(19) United States
(12) Patent Application Publication
(10) Pub. No.: US 2015/0067077 A1
(43) Pub. Date: Mar. 5, 2015

(54) PRIVATE MESSAGING AND PRIVATE SOCIAL NETWORK METHOD FOR CREATING PERSONAL AND PRIVATE ONLINE COMMUNITIES THROUGH CONNECTING USER(S) UTILIZING PHYSICAL OBJECTS AND/OR PRODUCTS AND ASSOCIATED UNIQUE CODE(S) LINKED TO USERS, MESSAGES, ACTIVITIES, AND/OR INFORMATION

(71) Applicants: Denise DiSano, Bedford, NY (US); Daniel DiSano, Bedford, NY (US)

(72) Inventors: Denise DiSano, Bedford, NY (US); Daniel DiSano, Bedford, NY (US)

(21) Appl. No.: 14/199,477

(22) Filed: Mar. 6, 2014

Related U.S. Application Data
(60) Provisional application No. 61/774,509, filed on Mar. 7, 2013.

(51) Int. Cl. H04L 12/58; H04L 29/06; H04L 29/08

(52) U.S. Cl. CPC H04L 51/32; H04L 67/22; H04L 63/20
USPC 709/206

(57) ABSTRACT

A method for creating personal and private online communities through connecting users utilizing physical objects and/or products associated with or having Unique Code(s) linked to member(s), message(s), activity(ies), and information. The invention connects individuals virtually or online in a private online community. The method implements at least one (1) computer, on-line, and/or virtual network, which hosts at least one (1) home page and/or webpage of at least one (1) private online and/or virtual community and uses at least one (1) database, in part or in whole, which stores Unique Code(s) printed on and/or associated with corresponding physical objects and/or products. At least one (1) physical object and/or product is exchanged between at least two (2) individuals. A private messaging and private social network method.

### CLAIM UNDER 35 U.S.C. 119(e)

This application claims the benefit under 35 U.S.C. 119(e) to U.S. Provisional Application No. 61/774,509, which has a filing date of Mar. 7, 2013.

### FIELD OF THE INVENTION

The present invention relates to a method, which implements and/or uses at least one (1) Computer, Computer Network and/or virtual Network, smart device, Mobile Device, which hosts and/or enables access and/or use of at least one (1) home page and/or webpage of at least one (1) private online community and uses at least one (1) database, in whole or in part, which stores information and/or codes printed on and/or associated or connected with corresponding physical objects and/or products, and/or cards. Each of the codes can be Unique Code(s). At least one (1) physical object and/or product, may be transferred from at least one (1) person to at least one (1) other person, and/or is exchanged between at least two (2) individuals. The method may utilize at least one (1) Computer, Computer Network and/or virtual network, smart device, and/or Mobile Device, that includes in at least one embodiment at least one (1) set of two (2) or more physical objects and/or products that: (i) are worn, carried, displayed, used, kept, transferred, and/or collected by at least one (1) individual; (ii) are exchanged, which means that at least one (1) physical object and/or product is given by a Giver to one (1) individual Receiver, between at least two (2) individuals in the real or physical world; (iii) each physical object and/or product contains, comes with, or is associated with at least one (1) Unique Code(s) which can be input or registered on a Computer Network and/or virtual network, computer, smart device, and/or Mobile Device to one (1) or more of the following: (a) display a personalized message; (b) view a Giver's profile and/or other information; (c) receive an invitation to join at least one online community; (d) receive an invitation to share your profile and/or other information, create and/or send private and/or personal messages, and/or other information; (e) provide invitations and thank you's for special events.

The Invention can be in at least one embodiment a method for creating personal and private online communities through connecting user(s) utilizing physical objects and/or products and associated code(s) linked to members, users, messages, activities, invitations, and/or information. Both a physical and virtual private messaging and private social network method.

### BACKGROUND OF THE INVENTION

Online social networking has become increasingly popular among tweens, defined as children including and between the ages of approximately seven (7) and fourteen (14) years of age. In recent years, popular social networking sites have included facebook.com, myspace.com, and twitter.com. Such websites are designed to be used by different and older demographics other than tweens and do not allow user(s) or members under thirteen (13) years of age. Many of the popular social networking websites do not accommodate tweens even through the entire tween years. There are certain websites that target tweens, such as clubpenguin.com, webkinz.com, and flipoutz.com. Such websites are more limited in their capabilities than the present invention and do not usually provide many of the services offered by their adult counterparts. Additionally, the adult counterparts do not offer the security and privacy that parents would be comfortable with.

Another growing trend among tweens is wearing and collecting collectible and uniquely designed novelty items, accessories, objects, and/or products, and sharing such collectible and uniquely designed novelty items, accessories, objects, and/or products among friends. Tweens often like exchanging novelty items and other objects or products with their friends to symbolize their friendship and to form a bond between such friends or among a group of friends.

The present invention combines aspects of a social networking website with physical wearable physical objects and/or products into an innovative invention, which allows tweens to give their friends physical objects and/or products and connect with their friend(s) in a private online community. The private online community can allow tweens to share private messages, express their individualism and connect only with friends and/or family, who they know on a personal level. At least one (1) Giver(s) can give at least one (1) physical object and/or product to at least one (1) Receiver(s), and said object and/or product can have, be connected to and/or be associated with at least one (1) personal invitation to connect with them in the private online community.

In addition to tweens, people of all ages including, but not limited to, adults can be Users of this invention.

### BRIEF SUMMARY OF THE INVENTION

The invention is a method comprising the utilization of physical objects and/or products to facilitate the sending and sharing of messages, information, and invitations, and/or connecting individuals virtually and/or online through private messaging and interaction in a private network and/or community. The method implements at least one (1) Computer, smart device, Mobile Device, Computer Network and/or virtual network, which hosts, accesses, displays, and/or operates software that executes at least one (1) program comprising at least one (1) homepage and/or webpage of at least one (1) private online community and at least one (1) database, which stores at least one (1) Unique Code(s) printed on, and/or associated with at least one (1) corresponding physical object and/or product. At least one (1) physical object and/or product is exchanged between at least two (2) individuals in one (1) embodiment and kept or collected by at least one (1) individual in another embodiment.

The method permits a User(s) to create and store his/her own User(s) profile, creating a private network currently known as FRIENDZ HUB™ and becoming a member of a private virtual or online community. A User(s) populates his/her FRIENDZ HUB™ with friends by following a variety of steps including, but not limited to, entering at least one (1) code(s) and transferring, giving, or keeping at least one (1) physical object and/or product containing or displaying a Unique Code(s). A physical object and/or product can be linked to at least one (1) other physical object and/or product. A Giver(s) can create, select, and/or associate at least one (1) personalized message to at least one (1) linked and/or associated physical object and/or product by registering on, accessing, and/or utilizing at least one (1) Computer, smart device, Mobile Device, Computer Network and/or virtual network in which at least one (1) Unique Code(s) is contained on, or associated with that linked the physical object and/or product. The User(s) can give the linked physical object and/or product to another individual, who can register or enter the code at a designated page of a website or Internet location through the use of a Mobile Device and application. The Computer Network will then retrieve the message associated with that Unique Code(s) and after recognition and verification may display the associated message, if any, to the Receiver of the physical object and/or product and/or invite him/her to join the private virtual or online community. The possessors of linked physical objects and/or products can connect with each other in the virtual or online private community. Only connected Giver(s) and Receiver(s) can see each other's profiles or communicate with each other. The Unique Code(s) used as described in this method expire after one (1) use and are not reusable.

In the current embodiment, the method allows User(s) under the age of thirteen (13) to access the online community only if they are given permission by their real world parent(s) or guardian(s) to do so. The associated website(s) and private virtual or online network(s) of this invention in the current embodiment are COPPA Compliant and are dedicated to child safety.

The private virtual or online community may feature games, which the User(s) can play on their own or with each other Giver(s) and Receiver(s), and are easy, safe ways to connect User(s) on a personal level. The method also allows User(s) to create at least one (1) webpage, which can be stored on a Computer, Computer Network and/or virtual network, smart device, Mobile Device, and/or database, about a specific social event(s) with information about the event(s). Such webpage is currently known as a Private Party Page(s). Guests are only allowed to see the Private Party Page(s) if they receive a physical object and/or product with a Unique Code(s), or physical objects and/or products with unique corresponding codes from a party host.

The method provides a way for individuals to connect with each other on a private online community by exchanging physical object(s) and/or products with or associated with Unique Code(s). Upon registering or entering the code(s) and signing up and/or logging in as a member of the community, the method of this invention permits individuals to connect and communicate with others privately online. Individuals with linked physical objects and/or products can become a sub-group(s) of another private virtual and/or online community or create a separate new private virtual and/or online community by linking to each other via exchanging, using, keeping, and/or maintaining physical objects and/or products with associated Unique Code(s).

Throughout the site we have something called a “page designer.” This is something the Users use to customize their site. This page designer is accessible throughout the site where User(s) can use templates, upload photos, video, backgrounds, stickers, frames, clip art shapes, shadows on the designated area to customize their site.

### BRIEF DESCRIPTION OF THE DRAWINGS

FIG. 1 shows a flowchart showing the logical steps of the method according to one (1) embodiment of this invention.

FIG. 1A is one (1) embodiment of a physical object and/or product in the form of a wristband on a hangtag or card that also displays a private code.

FIG. 2 shows examples of a physical object and/or product in the form of a wristband and gift and/or drawstring bags.

FIG. 2A shows boxes and packaging displaying wristbands and wristbands being worn.

FIG. 2B is one (1) embodiment of a physical object and/or product in the form of a wristband on a hangtag or card with the wristband covering the private code.

FIG. 2C shows one (1) embodiment of five (5) wristbands.

FIG. 3 is a screenshot of a home page (i.e. public landing page).

FIG. 4 shows screenshots of the setting up of a private account in the online community.

FIG. 5 is a proposed design of a profile page.

FIG. 6A is a screenshot of an online community friend list from a member's page.

FIG. 6B is a screenshot of an online community list of chat groups from a member's page.

FIG. 7A is a screenshot of a member's private journal.

FIG. 7B is a screenshot of a member's log of previous private messages from friends that have been linked together in a private network through the method.

FIG. 8 is one (1) embodiment and design of a webpage stored on a Computer Network of a social event called a Private Party Page(s).

FIG. 9A is a screenshot of one (1) embodiment of a Private Party Page(s) comprising a social event's photo album.

FIG. 9B is a screenshot of one (1) embodiment of a Private Party Page(s) comprising a social event's wish list from the host.

FIG. 10 is a screenshot of one (1) embodiment of steps for sending a private message using a Unique Code(s) retrieved from a physical object and/or product according to the invention.

FIG. 11 is a screenshot of one (1) embodiment of steps for receiving a private message using a Unique Code(s) retrieved from a physical object and/or product according to the invention.

FIG. 12 is a screenshot of one (1) embodiment of steps used in creating a social event and private message using a Unique Code(s) retrieved from a physical object and/or product according to the invention.

FIG. 13 is a screenshot of one (1) embodiment of steps used in receiving a preview of the Private Party Page(s) and details of a social event using a Unique Code(s) retrieved from a physical object and/or product according to the invention.

FIG. 14 is a flow chart depicting an embodiment of the method according to the invention.

FIG. 15 shows the space in which a private message can be created for access by friends who enter Unique Code(s).

### DETAILED DESCRIPTION OF THE DRAWINGS AND INVENTION

In the following detailed description, reference is made to the accompanying drawings that form a part hereof, and in which a specific embodiment(s) in which the invention may be practiced is shown by way of illustration. It is to be understood that other embodiments may be utilized and structural changes may be made without departing from the scope of the present invention.

In the following detailed description, numerous specific details are set forth in order to provide a thorough understanding of various aspects of one (1) or more embodiments of the invention. However, one (1) or more embodiments of the invention may be practiced without such specific details. In other instances, well-known methods, procedures, and/or components have not been described in detail so as not to unnecessarily obscure aspects of embodiments of the invention.

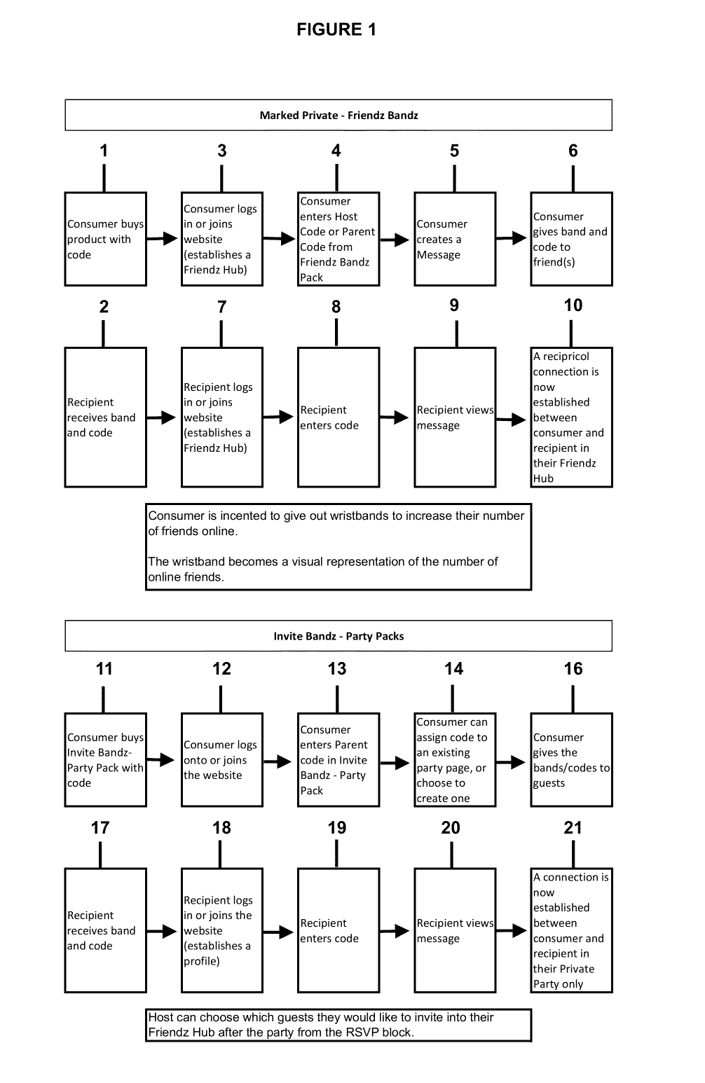

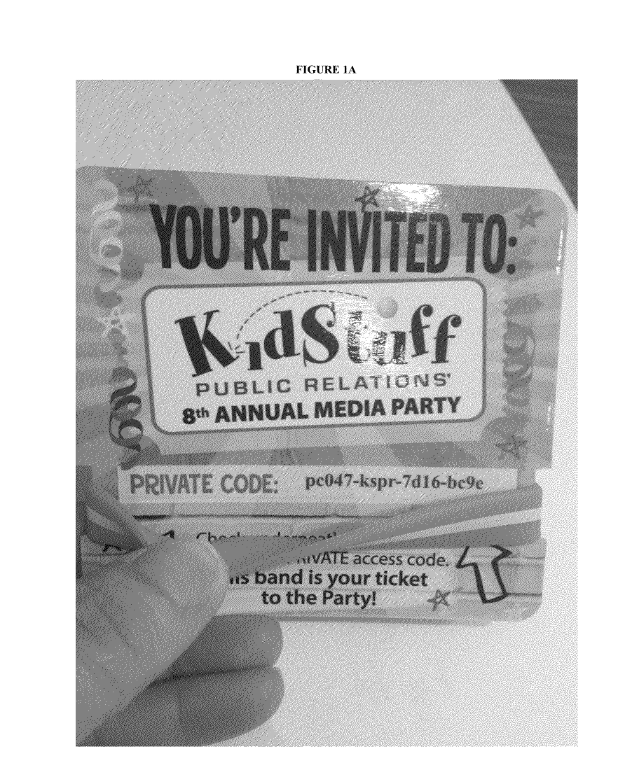

The invention comprises a method, which comprises physical objects and/or products with Unique Code(s) on or associated with them, at least one (1) Computer Network to host at least one (1) database, which stores Unique Code(s) and associates them with the physical objects and/or products displaying the codes, and the connecting of individual(s) on a private virtual or online community. In one (1) preferred embodiment, the physical objects and/or products are artfully designed wristbands, which may include a metal tab that is currently known as a slider, on which the Unique Code(s) are imprinted, attached, associated with and/or hidden behind, as shown by FIG. 1A, with a finger bending the wristband back to reveal the code. Such wristbands can be worn, displayed, carried around, and/or collected by a holder. In no way should this language be interpreted as an expressed limitation for this invention to be limited in its use. The physical objects and/or products can take on the form of various novelty items, including but not limited to jewelry, such as necklaces, bracelets, barrettes, rings, earrings, anklets, pendants, key chains, and holiday ornaments. The physical objects and/or products can also be displayed on various items, including but not limited to clothing, shoes, backpacks, and luggage. The physical objects and/or products can come in a variety of colors, sizes, and shapes.

In addition, the physical objects and/or products can be decorated with drawings, stickers, and other designs.

The Unique Code(s) displayed on or associated with the physical objects and/or products are registered online on at least one (1) website, the procedure of which is shown in the flow charts of FIG. 1. The website serves as the registrar of the codes. An individual then enters or registers at least one (1) code on the website, depending on whether he/she is a Receiver(s) or Giver(s) of the physical object and/or product and code. The Giver(s) buys at least two (2) physical objects and/or products with Unique Code(s) 1. The Receiver receives at least one (1) physical object and/or product with a unique Child Code 2. The Giver(s) logs in or joins the online community via a website 3, which may be achieved through the use of a Mobile Device and application, and registers or is associated with at least one (1) Parent Code on a website 4. If the individual is the Giver(s) of a physical object and/or product, he/she can create a private message, using at least one (1) of the following list of items comprising, but not limited to, photos, drawings, images, audio/recordings, video, text 5, templates, backgrounds, and/or stickers. Templates, backgrounds, and/or stickers are not shown in the Figure(s). The Giver(s) then gives the physical object and/or product to his/her friend(s), who is/are the Receiver(s) 6. If the individual is a Receiver of the physical object and/or product, he/she may join or log onto the private virtual or online community via a website 7. He/she enters the code 8 and then views any available personalized message from the Giver(s) of the physical object and/or product 9. Once the Receiver inputs the code the Receiver is connected to Giver's private network and such items are confirmed, approved, and recognized by the software, the Receiver is granted access and can choose to completely connect with the Giver(s) in the private virtual or online network, and is given the ability to view the Giver's online profile, and engage and post on the Giver's message board 10. The Giver(s) is usually given reciprocal capabilities when the Receiver inputs the code to connect.

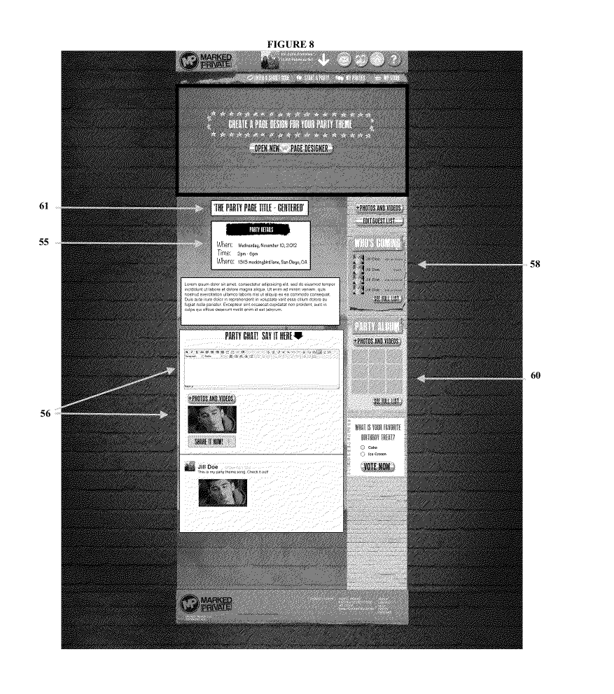

An individual may use the method to inform his/her friend(s) about a social event through the use of a Private Party Page(s), as shown in FIGS. 1 and 8. The individual can purchase INVITE BANDZ™, which includes a large number of physical objects and/or products with Unique Code(s) 11. The individual then logs on or joins the private online community via a website home page 12. The individual registers the codes 13 and can choose to create a party webpage or link the physical objects and/or products to an existing Private Party Page(s) 14. An individual may then distribute or give out the physical objects and/or products to his invitees or attendees 16. The Receiver(s) of the party physical objects and/or products receive the physical object and/or product with a code 17. He/she logs in or joins the website 18. This may be achieved through the use of a computer, smart device, and/or Mobile Device and application. He/she enters the code 19. He/she can view a personalized message 20. He/she will be prompted to view the party webpage 21. The Giver and Receivers can all communicate on at least one (1) Party Webpage.

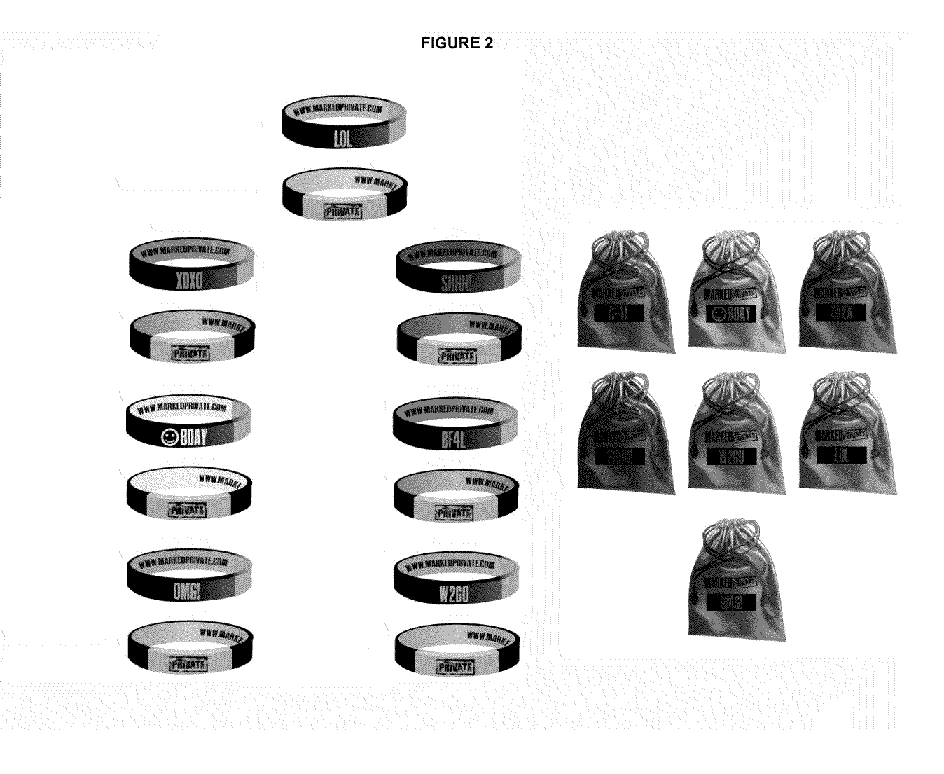

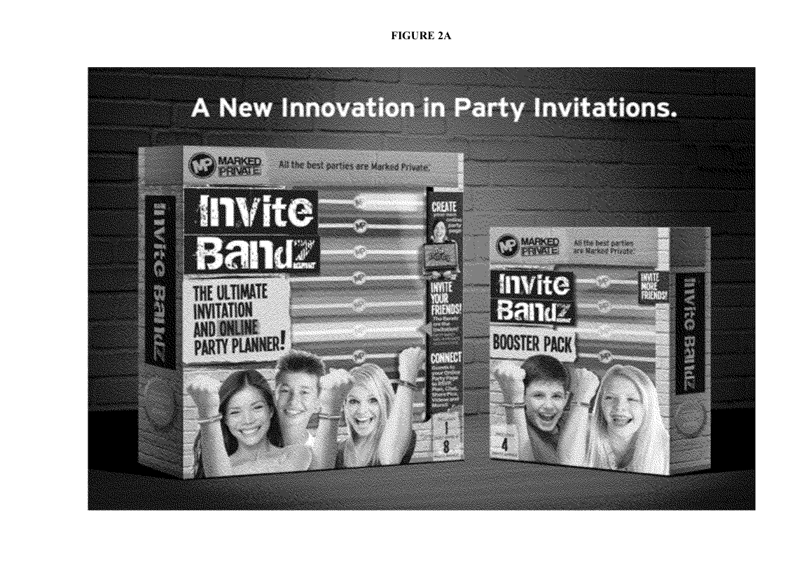

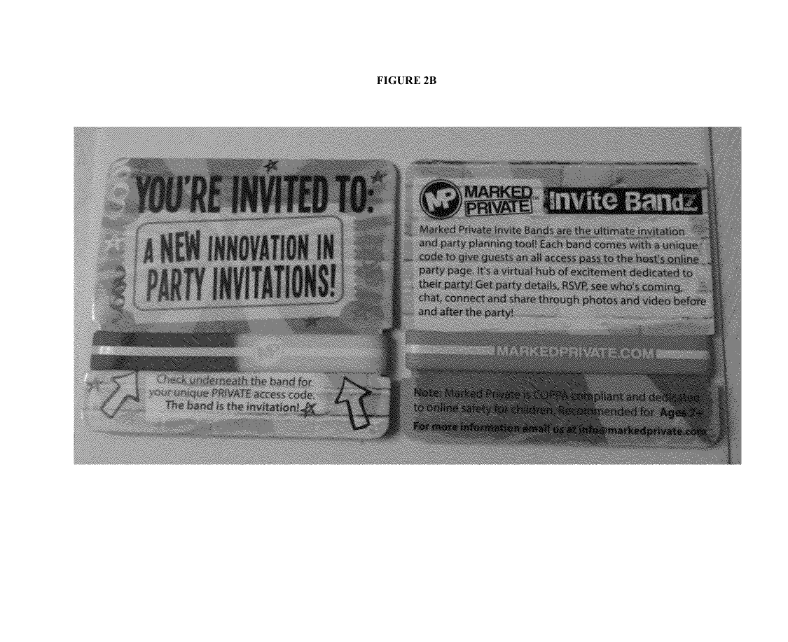

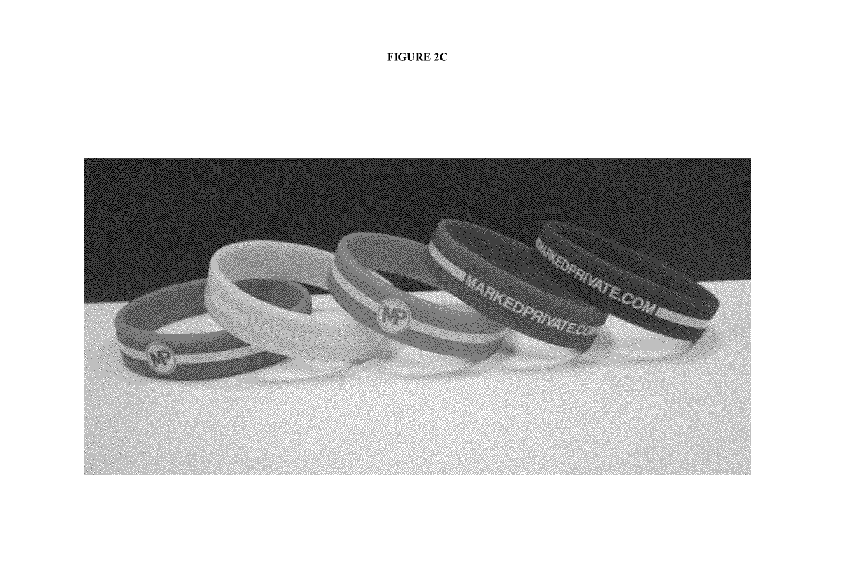

The physical objects and/or products can be in the form of wristband(s), as shown in FIGS. 1A, 2, and 2C. The front of the wristband(s) may display the word “PRIVATE,” “MARKED PRIVATE,” “MP,” a logo with “MP,” and/or any other text or logo. The Unique Code(s) can be associated with the wristband or can be displayed on the side of the band and may have a metal tab, or slider, or other means to conceal it.

In at least one (1) embodiment, on a webpage of a private virtual or online community the Receiver(s) of a physical object and/or product and associated code can create or complete a profile, as User(s) are granted limited access prior to retrieving a code, including the ability to create a profile, and invite other individuals to join the community and connect with the Receiver(s). By completing and entering their online profile, a User(s) starts their own separate virtual or online community. However a User(s) can only invite or communicate with other individuals if such User(s) becomes a Giver(s) to those individuals or is a Receiver(s). Only a person possessing at least one (1) of the Unique Code(s) can join the Giver(s)'s private virtual or online community by entering or registering the code and creating an online profile. In at least one (1) present embodiment the code expires after one (1) use. A Receiver of a code enters the Unique Code(s) on the page to retrieve his/her personalized message and create the online connection with the Giver(s). Members can also play games and earn points and in at least one (1) embodiment can see which member has the most points. Members can also create party/social event webpages called Private Party Page(s). A profile(s) comprises, but is not limited to, at least one (1) of the following: pictures, photos, audio, drawings, biography, blogs, news feeds, messages, stories, slogans, text, a word or words, a phrase or phrases, diary, private journal, prizes, friends list, points, accumulated points, videos, templates, backgrounds, and/or stickers.

A person can start an online or virtual community by virtually going to the method internet home page which is currently www.markedprivate.com, as shown in FIG. 3, or an equivalent thereto, creating a log-in, creating a profile, answering questions and/or adding additional information, and populating their club by giving out at least one (1) of the physical objects and/or products with Unique Code(s).

In one (1) current embodiment the following scenario occurs: When an individual chooses to create an online profile, he/she is prompted to answer a few basic questions about himself/herself, as shown in FIG. 4. For example, he/she may be asked for any combination of his/her first name and/or initial or initials 27, birth date 28, and/or gender 29. He/she may then be asked to create a personal password 30 and to provide their parents' emails 31. A message will pop up stating that the individual's parent must approve for the individual to join the private online community before he/she can get full access to all of the online community's features 32. The individual may then be asked to provide a list of favorites, such as favorite food, favorite color, favorite television show, favorite movie, favorite singer, and favorite sports team. A list of favorites, such as favorite food, favorite color, favorite television show, favorite movie, favorite singer, and favorite sports team is not shown in FIG. 4. After the individual fills out general information (i.e. answers to the basic questions) about himself/herself, he/she is prompted to view his/her personalized online profile.

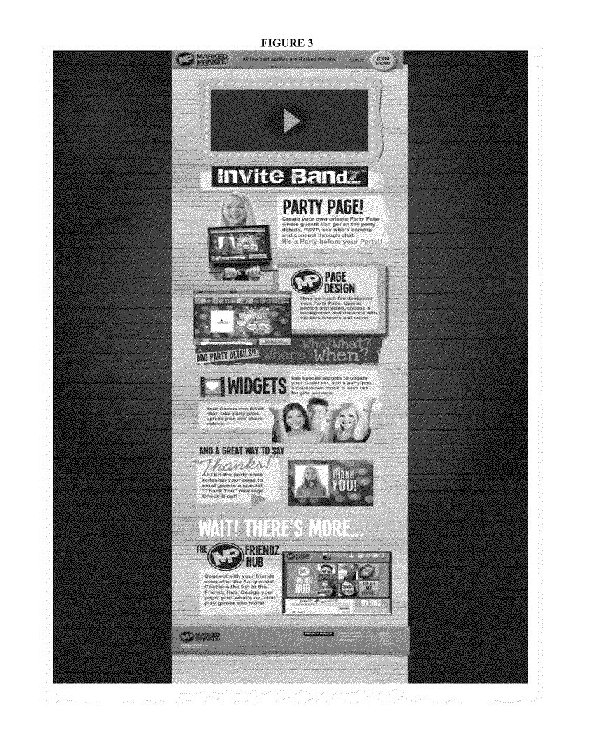

The online profile, known as FRIENDZ HUB™ is shown in FIG. 5. Individuals can blog about their thoughts and their connections can comment on their postings 38. Their connections can also “like” their postings 39. They can also post photos, images, drawings, audio/recordings, messages, text, videos, templates, backgrounds, and/or stickers on their online profiles 40. Their FRIENDZ HUB™ profile can also display general information about the individuals, such as their location, grade, birthday, and favorite movie, among others. Individuals can play games on their own or with other players that they are connected or linked with 41. Individuals may earn points from playing games or registering new codes, which may be used to purchase items from the website's “point shop” and/or point leaderboard 42. Individuals can see a list of their friends/connections 43 and/or social events that they have been invited to or are hosting 44.

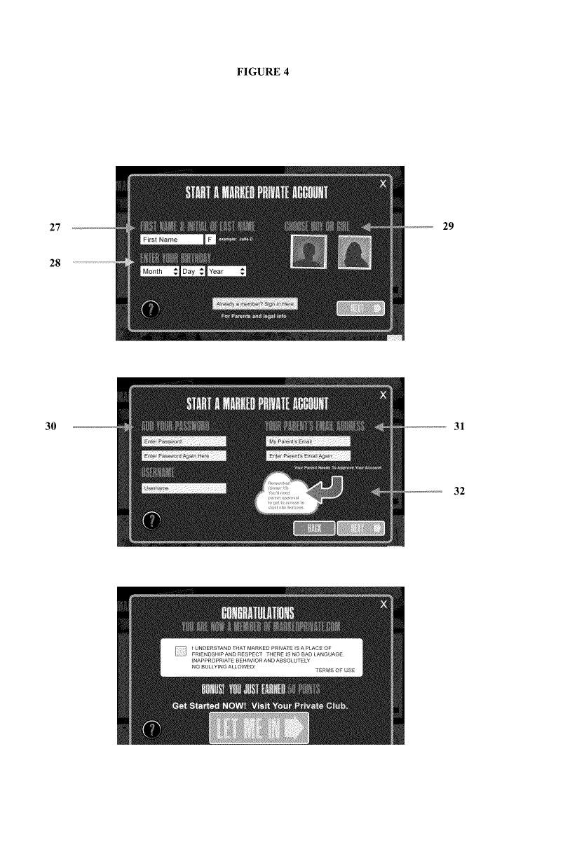

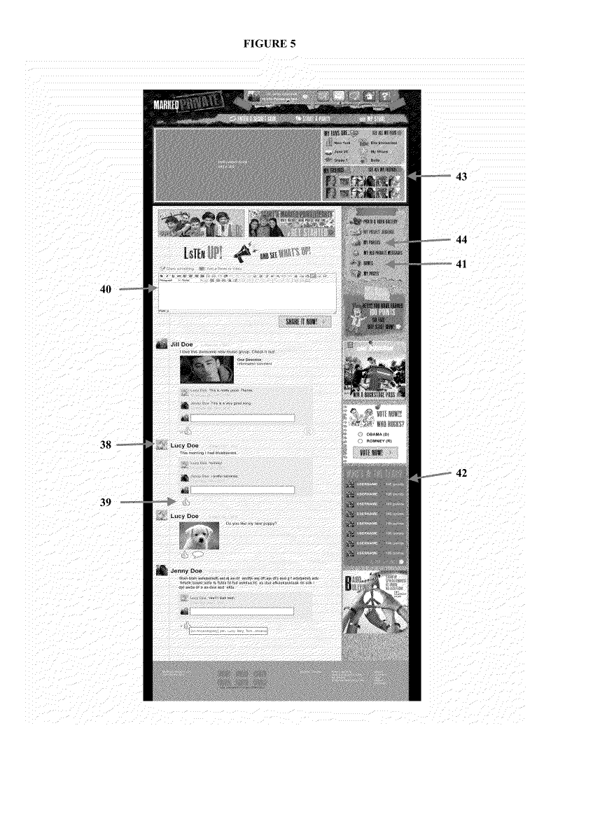

Members can view the profiles and/or sites of the members who are connected to them in their FRIENDZ HUB™ 45 and have pre-authorized such sharing or viewing, as shown in FIGS. 6A and 6B. Members can select friends to invite them to join into a private group chat 46 and give the group chat a name 47. Members can also view all the group chats they are participating in 48.

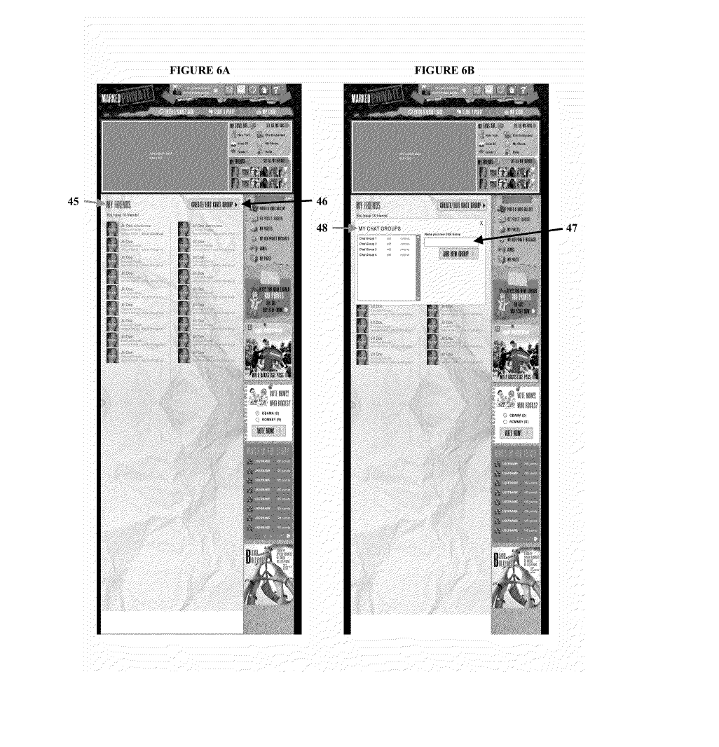

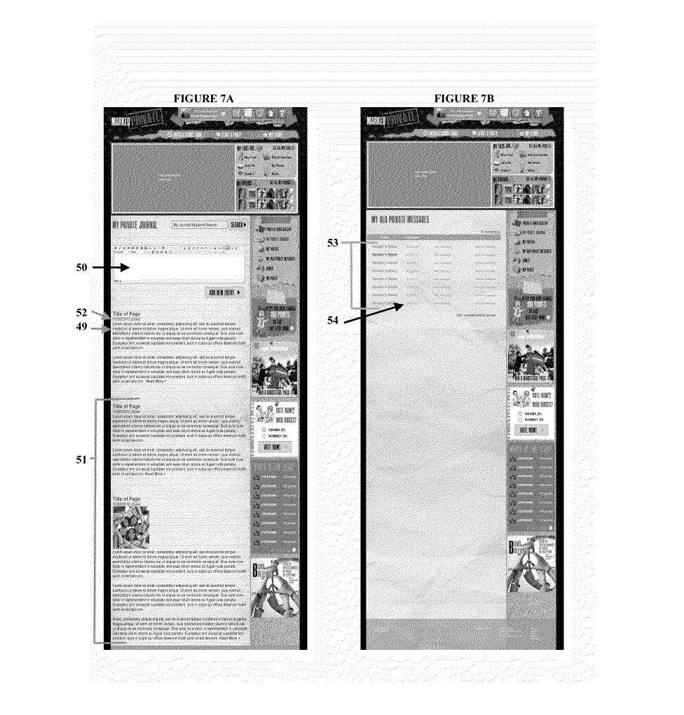

Members can compose a private journal on their profile, which can only be seen by the owner of such private journal, as shown in FIGS. 7A and 7B. The private journal is currently titled and known as “My Private Journal”, and allows the member to privately type out their thoughts 49, add an entry 50 to other entries 51. Each entry is dated 52. The messages and/or page designs are stored and saved in the event that the individual wants to see them 53 and the date is included 54 (“my designs”).

Members of the online community can create a webpage about a social event, as shown in FIG. 8. The page lists the details of the event, including location, time, and date of the event 55. There is a message board for the guests, which can include discussions of gift ideas, fashion tips, and other things related to the social event 56. The creator can also include a wish list, or countdown clock, which are not shown in FIG. 8 but can be used to inform his/her guests what kind of presents he/she wants and/or when the party will occur. The creator and invitees can see who has RSVP'd 58 to the event and who has not responded. Who has not RSVP'd to the event is not shown in FIG. 8. The creator and invitees can share photos, images, drawings, audio/recordings, messages, text, videos, templates, backgrounds, stickers, and/or other content to the party album 60. The creator can title the social event 61, and create a collage in the special block, which is shown in FIG. 8, including but not limited to photos, videos, images, text, phrases, words, slogans, messages, templates, backgrounds, stickers, etc. For example, the creator can attach a picture/video in the block above the title of the event.

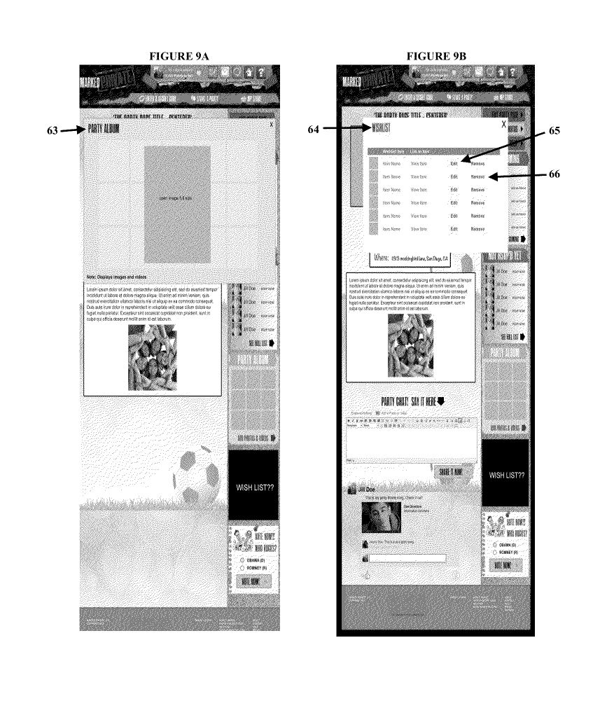

A host of a social event can create a party photo album and a wish list, as shown in FIGS. 9A and 9B. The party album 63 enables guests to see photos from the social event after the occurrence of the event, and also allows a host and guests to post photos, videos, etc. before and after the occurrence of the social event. The wish list 64 allows a host to list gifts that he/she would like to receive from his/her guests. The guest can view the wish list for gift ideas and the method may incorporate additional steps to provide for the purchase of gifts either virtual and/or physical. A host can remove 66 or edit 65 items on his wish list.

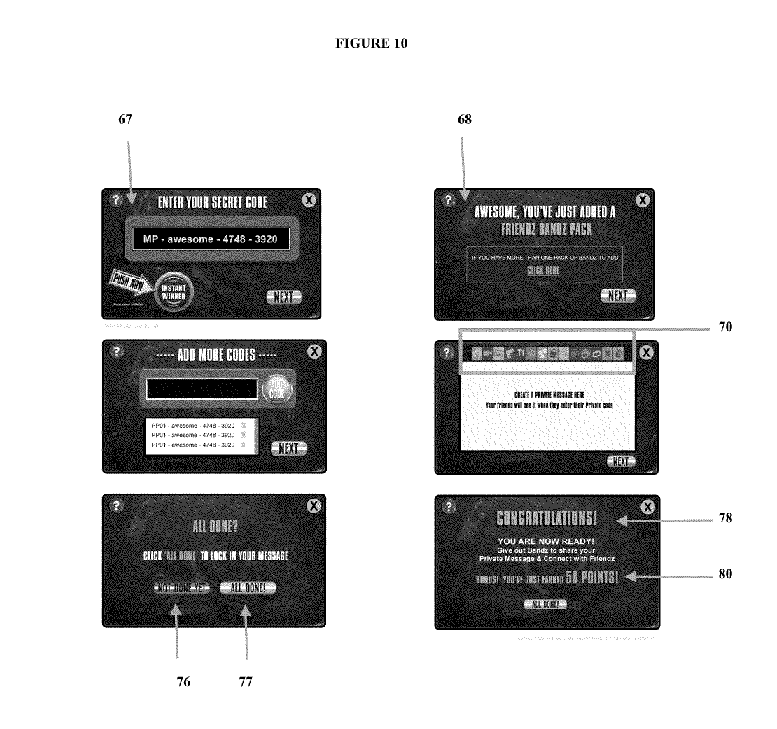

Members can create a personalized message on a website, as shown in FIG. 10. A member enters the code retrieved from a physical object and/or product and the website 67 will immediately recognize how many other physical objects and/or products are linked to that Parent Code(s) 68. For example, FRIENDZ BANDZ™ includes at least two (2) physical objects and/or products, with one (1) physical object and/or product associated with one (1) Parent Code and one (1) physical object and/or product associated with one (1) Child Code. The purchaser of FRIENDZ BANDZ™ retains the parent code and physical object and/or product and gives away the child code and physical object and/or product to the person that he/she wants to send a personalized message to, and connect with online. After the network identifies how many physical objects and/or products are linked, the member can continue on to creating a private message and/or invitation to an event.

The member can create a private message, using any type of content including but not limited to text, photos, videos, templates, backgrounds, stickers, etc. 70. The website can also be programmed to suggest ideas for a personalized message, if some are needed. Once a private message has been created, the member enters information or the message and/or clicks “Next”, or “Finish”, which takes the member to the next step. The member can then complete the process of creating a private message by verifying that he is done 77. If he/she wants to change something, he/she can also do so by clicking the “NOT DONE YET” button 76 on the website. The website will inform the member 78 that they are ready to give away physical objects and/or products and can also display how many points they have earned 80.

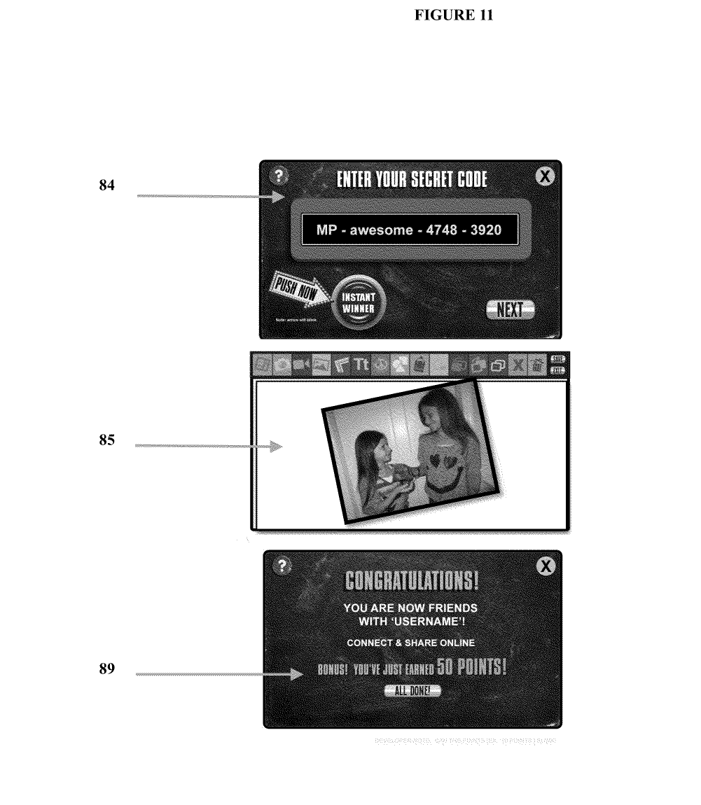

A Receiver of a physical object and/or product can retrieve a personalized message on a website, which may be achieved through the use of a computer, smart device, and/or Mobile Device and application, as shown in FIG. 11. The Receiver enters a code retrieved from a physical object and/or product on the website 84. The website will retrieve a personalized message if any are associated with that code and physical accessory. The message, which can be of any content form including but not limited to textual, audio, or video, will then be displayed 85. The Receiver will then be informed how many points he/she received for viewing the private message 89.

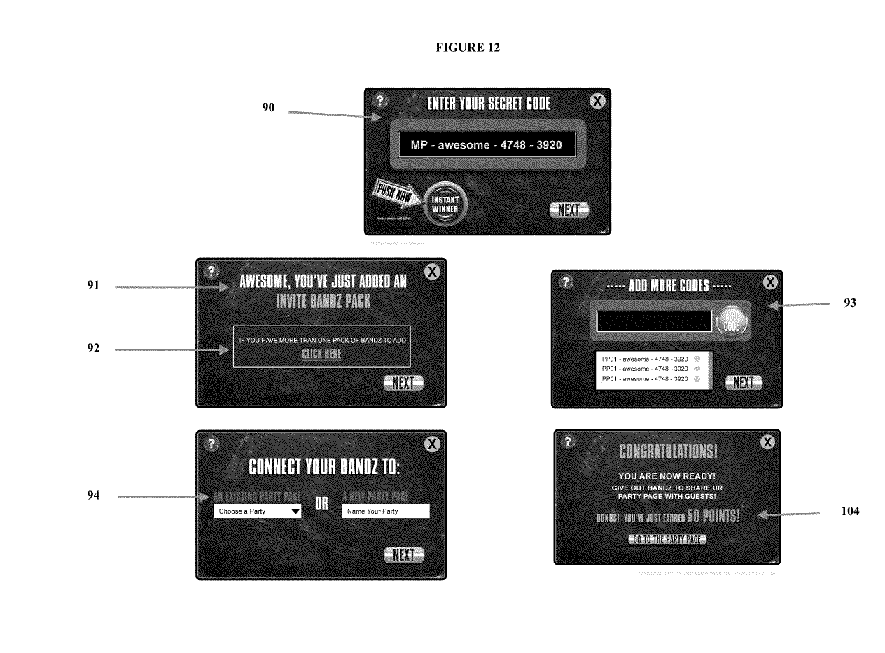

An individual can create a private message about a social event using a pack of INVITE BANDZ™ associated with Unique Code(s), as shown in FIG. 12. The individual enters a Unique Code(s) on the website 90, which may be achieved through the use of a computer, smart device, and/or Mobile Device and application. The website will recognize that an INVITE BANDZ™ associated code was entered 91 and ask the individual if he wants to enter more than one (1) INVITE BANDZ™ associated code 92. The individual will be prompted to enter the codes 93 on any additional Party Pack(s) that he wants to link to his social event. Once the codes are entered, the individual can choose whether to associate the pack of, or individual INVITE BANDZ™ with an existing social event or create a new social event 94. The method may include that, if it is a new social event or if there is a new name for the event, the individual can type in the name of the event. If the pack of, or individual INVITE BANDZ™ is being linked to an existing social event, the individual can choose which social event to link the physical objects and/or products to. The individual can choose to create a webpage about the social event called a Private Party Page(s). The individual will then create a personalized message, which can be visual, audio, or textual, to his/her guests on the party page. The website will inform the individual of how many points he earned for using the pack of, or individual INVITE BANDZ™ 104. The individual can visit the social event webpage if he chose to create one (1). If a page is created it will have RSVP options for the User(s) to choose from.

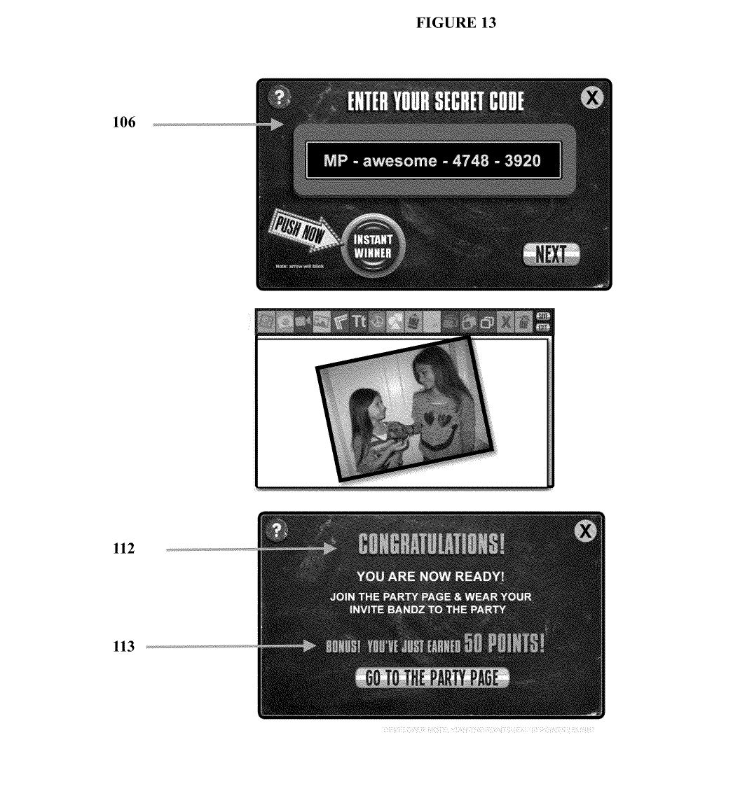

A guest can retrieve the details and personalized message associated with a social event on the website after receiving a pack of, or individual INVITE BANDZ™ associated with a Unique Code(s) from an event host, as shown in FIG. 13. The guest enters the Unique Code(s) on the website 106. The personalized message and details of the social event will be displayed. The guest then will be informed that he has successfully viewed the personalized message 112 and how many points he earned from viewing the message 113. The guest can view the Private Party Page(s).

The physical objects and/or products have a parent-child relationship. The parent physical object and/or product has a reciprocal linkage to at least one (1) child physical object and/or product. Therefore, the retainer of the Parent physical object and/or product can see the Receivers of the child physical object and/or product online profile and connect with that individual in the online community. Child physical objects and/or products have reciprocal relationships with Parent User(s). Receivers of child physical objects and/or products, which are linked to the same Parent physical objects and/or products, cannot view or join each other's FRIENDZ HUB™ or communicate with each other in the online community unless they are already connected or part of a party or event group.

The Computer Network involved in the execution of this method is written in computer code comprising Drupal and has elements of HTML 5, forming special computer code. The website can be evolved into a mobile application, which can be used on Mobile Devices. The website will also have a mobile version, which can be loaded with the browser of Mobile Devices with Internet capabilities.

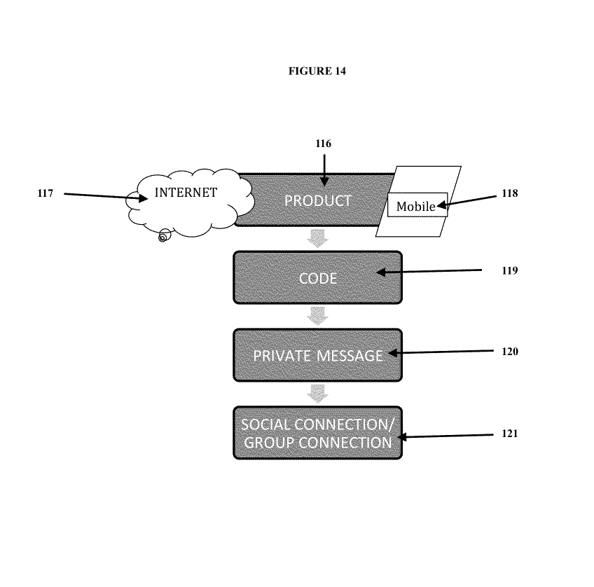

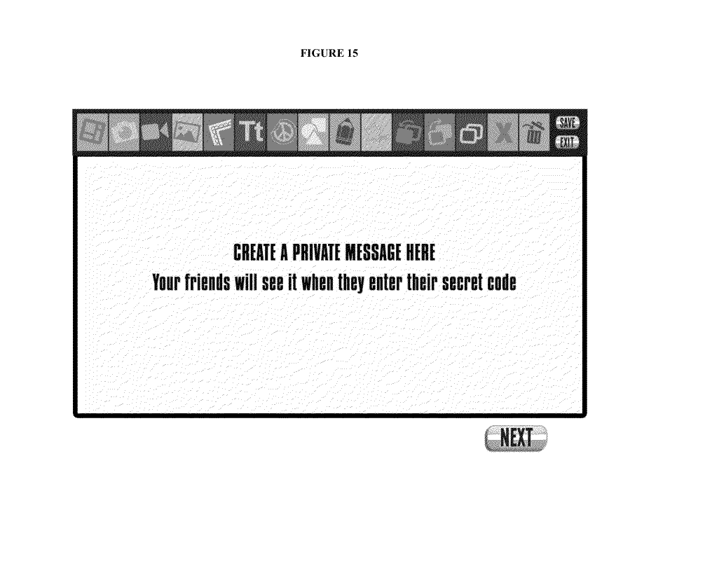

FIG. 14 shows the overall execution of the method. The product 116 or physical object and/or product with a Unique Code(s), which can be purchased and/or accessed 117 by a number of ways including but not limited to online on a computer and/or on a Mobile Device 118. The code 119 on or associated with an physical object and/or product can be entered at a webpage of a private online community by the User(s) utilizing a computer and/or on a Mobile Device. The individual(s) may be prompted and guided to create a private message 120 to be associated with the code that was entered, once he/she joins the community and creates his/her FRIENDZ HUB™ profile. However this step can be skipped if already done. Once the message is created, the individual can give the physical object and/or product to another individual, who then enters the associated code at a homepage once he/she creates his/her FRIENDZ HUB™ profile to see the message. The Giver(s) and Receiver have reciprocal capabilities to view and communicate with each other via their FRIENDZ HUB™ WebPages 121.

FIG. 15 shows a screen for creating a private message.

Throughout the website we have something called a Page Designer and/or Smash Board. This is something the users use to customize their site. This page designer is found throughout the site where children can use templates, upload photos, video, backgrounds, stickers, frames, clip art shapes, shadows on the designated area to customize their site.

The foregoing description of at least one (1) current preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one (1) or more embodiments of the invention may be practiced in combination or conjunction with one (1) another. Furthermore, the reference or non-reference to a particular embodiment of the invention shall not be interpreted to limit the scope the invention. It is intended that the scope of the invention not be limited by this detailed description, nor by the specific claims and the equivalents drafted herein.

Although preferred embodiments of the present invention have been described, it will be understood by those skilled in the art that the present invention should not be limited to the described preferred embodiments. Rather, various changes and modifications can be made within the spirit and scope of the present invention.

### DEFINITIONS

“Child Code(s)”: a code or codes associated with the physical object and/or product or physical objects and/or products being received from Giver(s). The Child Code links to the Giver(s)'s Parent Code on the computer network.
“Computer Network”: At least one (1) Computer Network, computer based network, or any equivalent or other equal or sufficient network capable of running software and/or an application, which can include Mobile Device(s).

### “COPPA”: Children's Online Privacy Protection Act.

“COPPA Compliant”: Websites that are collecting information from children under the age of thirteen are required to comply with Federal Trade Commission (FTC) Children's Online Privacy Protection Act (COPPA).
“Embodiment(s)”: one (1) or many embodiments.
“Event(s)”: one (1) or many events.
“Friend(s)”: one (1) or many friends.
“Giver(s)”: one (1) or more possessors of the Parent Code of a product or object.
“Group(s)”: one (1) or many groups.
“Guardian(s)”: one (1) or many guardians.
“Handheld Computing Device”: can have an operating system (OS), and usually can run various types of application software, known as apps. Most hand held devices can also be equipped with WI-FI, Bluetooth and GPS capabilities that can allow connections to the Internet and other Bluetooth capable devices such as an automobile or a microphone (1) headset. A camera and/or media player feature for video or music files can also be typically found on these devices along with a stable battery power source. Other types of Mobile Devices include tablet computers. As in a personal digital assistant (“PDA”), the input and output are often combined into a touch-screen interface, Smartphone(s) and PDAs Enterprise Digital Assistants may offer integrated data capture devices like barcode, RFID, optical, Optical Character Recognition, and smart card readers.
“Individual(s)”: one (1) or many individuals.
“Mobile Device”: is a generic term used to refer to a variety of devices that allow people to access data and information. A Mobile Device (can be also known as a handheld computing device, handheld device, handheld computer or simply handheld) can also be a hand-held computing device, which can have a display screen, which can also have a touch and/or stylus input and/or a miniature keyboard.
“Network(s)”: one (1) or many networks.
“Parent(s)”: one (1) or many parents.
“Parent Code(s)”: a code associated with the physical object and/or product or physical objects and/or products being kept and/or used by Giver(s) in an exchange process with Receiver(s).
“Private Party Page(s)”: an online webpage where the participants of a party and/or event can connect and/or interact by posting, viewing and/or sharing content to/with the webpage either prior to, during, or after a party and/or event.
“Receiver(s)”: one (1) or more possessors of a Child Code of the physical object and/or product received from the Giver(s).
“Unique Code(s)”: a unique identifier available in a number of various forms including, but not limited to, alpha numerical code, RF tag, QR code, scannable code, written code, pictorial code, 2-D code, 3-D code, barcode, microwave signal, electromagnetic signal, RF signal, IR signal, acoustic signal, or electronic signal, among others.
“User(s)”: Giver(s) and/or Receiver(s).
“Website(s)”: one (1) or many websites.
“Wristband(s)”: one (1) or many wristbands.

What is claimed:

1. A method for connecting user(s) in at least one (1) private virtual or online community that utilizes at least one (1) physical object and/or product having/or associated with at least one (1) unique code linked to information and/or private information, comprising in no specific order the following steps:
a. at least one (1) of generating, creating, accessing, and/or utilizing at least two (2) unique codes;
b. storing at least two (2) unique codes;
c. selecting and/or associating each code with at least one (1) corresponding physical object and/or product or multiple codes with multiple or at least one (1) corresponding physical objects and/or products;
d. generating, creating, accessing, and/or utilizing at least one (1) profile;
e. obtaining at least one (1) set of two (2) or more physical objects and/or products associated with unique codes;
f. creating, accessing, and/or utilizing information linked to each or at least one (1) unique code or codes;
g. at least one (1) of transferring, giving, or keeping at least one (1) physical object and/or product;
h. generating, creating, accessing, and/or utilizing at least one (1) more profile; and
i. utilizing and/or accessing at least one (1) code for retrieving and displaying information linked to that code or utilizing multiple codes for retrieving and displaying information linked to respective corresponding codes.

2. The method of claim 1, further comprising at least one (1) of: the use of at least one (1) computer and/or virtual network to execute the method and at least one (1) database to store user data and information, or the use of at least one (1) computer and/or virtual network to execute the method for connecting a user or users in at least one (1) private virtual or online community in connection with utilizing a physical object and/or product having a unique code or multiple physical objects and/or products having unique corresponding codes which are linked to a private message or private messages.

3. The method of claim 2, wherein the data and information is gathered, displayed, and/or stored, in the form of at least one (1) of the following: codes, profiles, messages, invites, points, private club data, private hub data, event data, private information, and/or information.

4. The method of claim 1, wherein each profile is, or multiple profiles are, comprised of at least one (1) of the following information: name, user name, age, gender, parent email, favorites, first name or initial, last name or initial, middle name or initial, log-in, user name, password, birthday, pictures, photos, audio, drawings, biography, blogs, news feeds, messages, messages log, stories, slogans, text, a word or words, a phrase or phrases, diary, private journal, prizes, friends list, points, accumulated points, games, prizes, leader boards, contests, videos, templates, backgrounds, and/or stickers, private information, and/or information; and any or all of the information in the profile or profiles can be private information.

5. The method of claim 1, wherein the transferring of an object and/or product or multiple objects and/or products, if applicable, is performed by a type of user called a Giver(s), the utilizing of a code or codes for retrieving and/or displaying information or private information is performed by a type of user called a Receiver(s), the retrieving and/or displaying of information is for a Receiver(s) of an object and/or product or multiple objects and/or products, and the method further comprises a step of transferring information from a Giver(s).

6. The method of claim 1, additionally including at least one (1) of the following:
a. wherein the at least one (1) virtual or online community has at least one (1) member and each member of the at least one (1) virtual or online community does not have full access to features without parental approval; and/or
b. wherein the at least one (1) virtual or online community has at least one (1) member and at least one (1) member of the at least one (1) virtual or online community does not have full access to features without parental approval; and/or
c. wherein the at least one (1) virtual or online community has at least one (1) member and at least one (1) member of the at least one (1) virtual or online community must have parental approval in order to have full access to features if such member is under thirteen (13) years of age.

7. The method of claim 6, further comprising the linking of each unique code to one (1) or more of the following:
a. at least one (1) invite to at least one (1) private virtual or online community;
b. at least one (1) opportunity to connect with other members of the community; and/or
c. at least one (1) private message.

8. The method of claim 7, wherein the linking of a code(s) allows for an opportunity to connect with other member(s) of the community, which requires at least one (1) of:
a. an additional code; and
b. at least one (1) object and/or product, or additional codes and respective corresponding objects and/or products.

9. The method of claim 1, wherein at least one (1) code is necessary to perform at least one (1) of the following:
a. access private information;
b. access information;
c. connect with others on a private network; and/or
d. set up or complete a new user profile.

10. The method of claim 1, wherein the code(s) can be used to perform at least one (1) of the following:
a. retrieve information;
b. create at least one (1) Giver(s)'s information or private information;
c. create at least one (1) Giver(s) and at least one (1) Receiver(s) connection;
d. and/or further comprises the step of a Giver(s) entering a unique code into a device connected to a computer network and having at least one (1) of the following occur:
i. a system notification code is activated; and/or
ii. the system is placed on alert awaiting the entering of the related child code by corresponding Receiver(s).

11. The method of claim 1, wherein when the code(s) is/are entered by Receiver(s), the specific unique code(s) is/are expired.

12. The method of claim 1, further comprising at least one (1) or more of the following steps:
a. logging into a webpage stored on at least one (1) computer network and/or mobile device;
b. entering or registering at least one (1) unique code or multiple codes on at least one (1) webpage of at least one (1) computer network and/or mobile device; and/or
c. creating, accessing, and/or utilizing or completing a profile; and/or
d. first entering or registering at least one (1) code or codes virtually or online to access and/or utilize information.

13. The method of claim 1, further comprising entering or registering at least one (1) unique code virtually or online, and creating, accessing, and/or utilizing a profile or profiles in part or the complete profile or profiles prior to entering or registering at least one (1) unique code virtually or online.

14. The method of claim 1, wherein the object and/or product is one (1) or more of the following including but not limited to: invite cards, cards, stationary, envelopes, wrist bands, necklaces, key chains, bracelets, earrings, anklets, pendants, rings, wristbands, clothing, apparel, objects and/or products, headgear, hats, jewelry, toys, novelties, gifts, soft toys, plush toys, dolls, collectible items, memorabilia, and/or Christmas tree ornaments.

15. The method of claim 1, wherein the object(s) and/or product(s) is/are worn, carried, displayed, collected, stored, and/or showcased.

16. The method of claim 1, wherein the information is one (1) or more of the following:
a. a personalized message to Receiver(s) of an object and/or product or multiple objects and/or products;
b. a message;
c. information;
d. a thank you;
e. an invite to connect with and view at least one (1) stored online profile of Giver(s) of an object and/or product or objects and/or products with a code or codes; and/or
f. a message, information, thank you, and/or invite from a host to a guest for attending his or her social event.

17. The method of claim 16, wherein the personalized message is comprised of any content including but not limited to at least one (1) of the following: text, phrases, slogans, pictures, drawings, art, music, audio, recordings, photos, background, templates, stickers, and/or video.

18. The method of claim 1, wherein the information can only be retrieved by Receiver(s) of an object(s) and/or product(s) containing a unique code(s) in a Giver(s) to Receiver(s) relationship, and further comprising the following step:
j. Receiver(s) using the unique code or codes to retrieve the information.

19. The method of claim 18, further comprising the following step:
k. Receiver(s) of an object(s) and/or product(s) setting up, creating, utilizing, and/or accessing a profile or multiple profiles and creating, accessing, and/or utilizing his/her own private community, and wherein Step k initially must be performed before Step j.

20. The method of claim 1, wherein the profile or profiles cannot be viewed by a Receiver(s) without a Giver(s) of the profile or profiles sending a personal invite to the Receiver(s) to view his/her profile and/or connect with that Giver(s) on a private virtual or online community by Receiver(s) entering a code(s) Receiver(s) have received from being given an object(s) and/or product(s) with a unique code and/or with unique respective corresponding codes.

21. The method of claim 1, additionally including at least one (1) of the following steps:
a. wherein only Giver(s) are virtually connected to at least two (2) Receiver(s) and the at least two (2) Receiver(s) cannot communicate with each other directly within the private virtual or online community or have any access to each other's information or profile or profiles; and/or
b. wherein only Giver(s) are virtually connected to at least two (2) Receiver(s) and the at least two (2) Receiver(s) cannot communicate with each other directly within the private virtual or online community or have any access to each other's information or profile or profiles unless at least one (1) Receiver(s) become Giver(s) to at least one (1) other Receiver(s) within a private virtual or online community at which time these two (2) users can communicate directly with each other within this same private virtual or online community and share information and profiles, additional Receiver(s) can become Giver(s) to at least one (1) other Receiver(s) within a private virtual or online community to connect directly and share information and profiles.

22. The method of claim 1, wherein the object(s) and/or product(s) can be connected in a parent-child relationship.

23. The method of claim 1, wherein the object(s) and/or product(s) is/are connected in a parent child relationship, comprising:
a. an object and/or product retained by a Giver(s) that can connect to at least one (1) Receiver(s)'s object and/or product;
b. a Receiver(s)'s object(s) and/or product(s) code(s) can be used to connect to at least one (1) private virtual or online community of the Giver(s), but the Receiver(s) object(s) and/or product(s) cannot be used to connect to another Receiver(s)'s private virtual or online community;
c. Only the Giver(s) is being virtually connected to at least two (2) Receiver(s) and the at least two (2) Receiver(s) cannot communicate with each other directly in a one (1) to one (1) relationship within the private virtual or online community or have any access to each other's information or profile or profiles unless at least one (1) Receiver(s) becomes a Giver to at least one (1) other Receiver(s) within a private virtual or online community at which time these two (2) users can communicate directly with each other within a private virtual or online community and share information and profiles. Additional Receiver(s) can become Giver(s) to at least one (1) other Receiver(s) within a private virtual or online community to connect directly and share information and profiles; and/or
d. Giver(s) and at least one (1) Receiver(s) can communicate with each other in a chat group with all participants in the chat being able to communicate with any other participants in the chat.

24. The method of claim 1, wherein the information is one (1) or more of the following:
a. an invitation to a party or social event; and/or
b. an invitation to view a webpage stored on at least one (1) computer network about a party or social event.

25. The method of claim 24, wherein the webpage comprises at least one (1) of the following: guest list, RSVP information, updates, textual messages, party title, party theme block, decorated backgrounds, videos, photos, text, stickers, party date, party time, party location, other party details, art board, page designer, party chat, photo/video gallery, private club friending option, wish list of gifts, host generated polls, and/or audio.

26. The method of claim 1, further comprising allowing members of a private virtual or online community to play computerized games.

27. The method of claim 1, further comprising an e-commerce platform either associated with, connected to, linked to, part of a main website/webpage or a separate site whereby members of a private network are offered goods and/or services for purchase and can purchase physical and/or virtual products, wherein the user can earn points and/or instantly win points or particular items, the points can be earned by various activities including, but not limited to, activating the object(s) and/or product(s), and wherein points can be used to purchase items in a virtual or online store.

28. The method of claim 1, wherein unique codes are at least one (1) of the following: given, offered for sale, sold, traded, auctioned, awarded, and/or purchased.

29. The method of claim 27, wherein the items available for purchase or purchased by members of a private virtual or online network comprise virtual products such as; virtual games, code message backgrounds, party page backgrounds, avatars, stickers, wallpaper, themed templates, virtual computer games, online computer games, and/or computer games.

30. The method of claim 1, wherein the private virtual online network(s) is/are a closed social network or networks.

31. The method of claim 1, wherein the object(s) and/or product(s) can receive information or data via download or other equivalent, and/or transmit information and/or data.

32. The method of claim 1, further comprising at least one (1) of the following:
a. the printing of at least one (1) of the following: stickers, labels, and/or cards; and/or
b. the printing of codes on at least one (1) of the following: stickers, labels, and/or cards.

33. The method of claim 1, wherein User(s) has the opportunity to acquire value in the form of points and/or designated points for such User's performance of various functions and/or tasks within the invention, such as connecting with another User(s), sharing profile and/or other content with another User(s), and/or planning an event through the invention, among others.

34. The method of claim 1, wherein a User utilizes at least one (1) of the following in order to redeem such User's acquired value, which is in the form of points and/or designated points:
a. at least one (1) platform for selling an object(s) and/or product(s) whereby the User exchanges a set value from such User's acquired value with the at least (1) platform in return for such object(s) and/or product(s); and/or
b. at least one (1) platform for selling a code(s) whereby the User exchanges a set value from such User's acquired value with the at least (1) platform in return for such code(s); and/or
c. creating, accessing, and/or utilizing a game platform or associated goods by User exchanging a set value of such User's acquired value in return for such creation, access, and/or utilization of such game platform and/or associated goods.

35. A method, comprising utilizing at least one (1) computer network and including at least one (1) physical object and/or product, the at least one (1) physical object and/or product being at least one (1) of:
a. worn, carried, displayed, or collected by at least one (1) individual;
b. exchanged, transferred, given, between individuals in the real world; and/or
c. containing or being provided with at least one (1) unique code which can be inputted or registered on the at least one (1) computer network to perform at least one (1) of the following:
i. display a personalized message;
ii. invite a user to join a virtual or online private community stored on a computer network; and/or
iii. provide an opportunity to connect with other members of the community.

36. A method of connecting individuals online in a private online community, comprising implementing at least one (1) computer network, which hosts at least one (1) website homepage of at least one (1) private virtual or online community, and implementing at least one (1) database, which stores unique codes printed on at least one (1) object and/or product, which is at least one (1) of:
a. exchangeable between at least two (2) individuals;
b. transferable between at least two (2) individuals; and/or
c. kept by one (1) individual.

37. The method of claim 36, further comprising at least one (1) individual utilizing at least one (1) device to access the at least one (1) website homepage, wherein the at least one (1) device is a mobile device, and the mobile device can have Internet access and can utilize a mobile application.

38. The method of claim 37, wherein the website can also have a mobile version, which can be loaded utilizing the browser of mobile devices with Internet and/or virtual capabilities.

39. The method of claim 1, wherein the unique code or codes are created by at least one (1) proprietary algorithm.

40. The method of claim 2, wherein the at least one (1) computer network comprises various component parts, both hardware and software, including but not limited to at least one (1) of the following:
a. Drupal with elements of HTML 5; and/or
b. a MYSQL database.

41. A method for connecting user(s) in at least one (1) private virtual and/or online community that utilizes a physical object and/or product having at least one (1) unique code, or multiple physical objects and/or products having unique codes, linked to private information, comprising in no specific order the following steps:
a. at least one (1) of generating, creating, accessing, and/or utilizing at least one (1) unique code;
b. storing at least one (1) unique code;
c. selecting and/or associating each code with a corresponding physical object and/or product or multiple codes with multiple corresponding physical objects and/or products;
d. generating, creating, accessing, and/or utilizing at least one (1) profile;
e. obtaining at least one (1), or at least one (1) set of two (2) or more, physical object(s) and/or product(s), associated with at least one (1) unique code(s);
f. creating, accessing, and/or utilizing information linked to each unique code or codes;
g. at least one (1) of transferring, giving, or keeping at least one (1) physical object and/or product;
h. generating, creating, accessing, and/or utilizing at least one (1) more profile; and
i. utilizing at least one (1) code for retrieving and displaying information linked to that code or utilizing multiple codes for retrieving and displaying information linked to respective corresponding codes.

42. The method of claim 1, whereby the physical object and/or product is multiple physical objects and/or products that are collectible items, and/or memorabilia.

43. The method of claim 1, whereby the Giver(s) of a physical object and/or product is one (1) or more of the following: a person and/or people, a company, an organization, a club, an event, a product, a promotion, a party, a conference, a convention, an amusement park, a museum, and/or medical records.

44. The method of claim 41, whereby the Giver(s) of a physical object and/or product is one (1) or more of the following: a person and/or people, a company, an organization, a club, an event, a product, a promotion, a party, a conference, a convention, an amusement park, a museum, and/or medical records.

45. The method of claim 1 additionally comprising at least one (1) “page designer” option on at least one (1) webpage for the User(s) to customize their website in at least one (1) of the following ways: use of templates, uploading of photos, video, backgrounds, stickers, frames, clip art shapes, and shadows on designated area(s).
